(19) United States
(12) Patent Application Publication
(10) Pub. No.: US 2005/0289185 A1
(43) Pub. Date: Dec. 29, 2005

(54) Apparatus and methods for accessing information in database trees

(75) Inventors: Brent L. Hadley, Kent, WA (US); Patrick J. Eames, Newcastle, WA (US); Susan C. Chew, Issaquah, WA (US)

Correspondence Address: BLACK LOWE & GRAHAM, PLLC, 701 FIFTH AVENUE, SUITE 4800, SEATTLE, WA, 98104, US

(73) Assignee: The Boeing Company, Chicago, IL (US)

(21) Appl. No.: 10/879,257

(22) Filed: Jun. 29, 2004

(51) Int. Cl. G06F 7/00

(52) U.S. Cl. 707/200

(57) ABSTRACT

Systems and methods for accessing information from database trees are disclosed. In one embodiment, a system for acquiring a link includes a database having a plurality of links obtained from at least a first source document and a second source document and a processor in communication with the database to search the database for links according to predetermined criteria and to extract the links from the database. In another embodiment, a method of forming a link between a first portion of a document and a second portion of a document includes specifying a first descriptor and a second descriptor, accessing a database, identifying a link in the database that defines a path between the first portion and the second portion, extracting the link and using the path to provide a user-manipulable link to refer a user from the first portion to the second portion.

### FIELD OF THE INVENTION

This invention relates generally to systems and methods for information management, and more particularly, to systems and methods for accessing information in database trees.

### BACKGROUND OF THE INVENTION

In recent years, commercial enterprises have increasingly transferred documents of various types into information databases that may be directly accessed by a user. Information databases offer a level of convenience to a user because they do not require the user to access physical volumes containing indexed information, or to access drawing files, and the like. Similarly, the use of information databases is advantageous to commercial enterprises because it allows significant cost savings. For example, the information database generally supports “paperless” operation, thus generally eliminating paper and printing costs. The use of information databases also largely eliminates the substantial floor space requirements generally associated with document libraries, filing cabinets and drawing files, which are typically used to store paper documents. Most importantly, the use of information databases significantly reduces the amount of time a user must devote to acquiring needed documents.

As information databases increase in size, however, ease of access to desired information has correspondingly increased in difficulty. In particular, current information databases are typically configured in a prescribed hierarchy of topics that generally resemble an inverted tree, having a root portion or main directory positioned at the top portion of the inverted tree, with branch portions that include specific document portions extending therefrom. Current methods for accessing desired information in such databases usually require that a user manually navigate downwardly from a main directory along pre-existing paths in the tree structure in order to locate an item of interest. If the user needs to move among branch portions, the user must generally navigate back to the main directory and then select a new path to access the desired information. Although hyperlinks may assist a user in moving directly between items in the document tree, the hyperlinks are not formulated by the user and thus may not provide the flexibility that a user desires.

One example of an information database that is arranged as a document tree is the Portable Maintenance Aid (PMA) that is offered by The Boeing Company of Chicago, IL. The PMA includes aircraft maintenance information in a readily accessible format so that maintenance personnel may conveniently obtain desired maintenance information and view the information on a viewing device. FIG. 1 is a graphical view of a portion of the PMA 10 that includes a main directory 12 that lists a plurality of electronic documents that are available for a particular aircraft model, including, for example, an electronic version of an aircraft illustrated parts catalog (AIPC), an electronic version of an aircraft maintenance manual (AMM), as well as other documents that are typically required to properly maintain the aircraft. To access a desired portion of a document, a user first selects a document in the main directory 12, and then navigates along predetermined paths that proceed from the most general topic, as listed in the main directory 12 to a more specific entry. For example, and with reference to the main directory 12, the user may select a document 13 (e.g., the AMM) and then navigate downwardly in the AMM document tree to locate a desired portion 14 of the selected document 13 (e.g., a recirculation fan installation procedure in chapter 21-25-07). From the portion 14, an illustration 15 (e.g., illustration 21-25-07/401) may be accessed and viewed.

Although the PMA 10 affords significant advantages and constitutes an advance in the state of the art, a user is still constrained to move, or “drill down” within the PMA 10 along predetermined paths in the document tree. Accordingly, if the user needs to view other related information that is present in the document tree, the user must generally navigate back to the main directory 12 and then proceed along another selected route to access the desired information. Moreover, if the user requires information not included in the document tree, the user must typically exit the selected document tree and then access another desired document tree. Once accessed, the user navigates through the second tree in the manner described above. For example, and still referring to FIG. 1, if a user required access to information contained in the AIPC while the user was accessing the AMM, the user would typically return to the main directory 12 and then access the AIPC.

Therefore, a need exists for systems and methods that permit a user to access document links and to move within a document tree in a more efficient manner than may be realized using the prior art systems and methods.

### SUMMARY OF THE INVENTION

The present invention comprises systems and methods for accessing information in database trees. In one aspect, a system for acquiring a referential document link includes a database having a plurality of referential links obtained from at least a first source document and a second source document, and a processor in communication with the database that is operable to search the database for referential links according to predetermined criteria and to extract the links from the database, the links defining referential paths between the first source document and the second source document.

In another aspect, a method of forming at least one referential link between a first selected portion of a document and a second selected portion of a document includes specifying a first descriptor associated with the first selected portion and a second descriptor associated with the second selected portion, accessing a database that includes a plurality of referential links, identifying the at least one referential link that defines a corresponding referential path between the first selected portion and the second selected portion, extracting the at least one referential link from the database, and using the referential path to provide a user-manipulable functional link to refer a user from the first selected portion to the second selected portion.

In still another aspect, a method of creating at least one referential link between a selected portion of a first document tree and a selected portion of a second document tree includes identifying a first descriptor associated with the selected portion of the first document tree and a second descriptor associated with the selected portion of the second document tree searching a database having a plurality of referential links obtained from the first document tree and the second document tree selecting at least one referential link from the database to form a corresponding referential path between the selected portion of the first document tree and the selected portion of the second document tree, and navigating from the selected first portion of the first document tree to the selected portion of the second document tree along the referential path.

Another aspect of the invention includes a displayable document generated from a database comprised of a plurality of referential links obtained from a first source document and a second source document, wherein the displayable document includes at least one referential link that forms a corresponding referential path from a selected portion of the first source document to a selected portion of the second source document.

Still another aspect of the invention includes a computer readable medium generated from a database comprised of a plurality of referential links obtained from a first source document and a second source document, wherein the computer readable medium includes at least one referential link encoded thereon that forms a corresponding referential path from a selected portion of the first source document to a selected portion of the second source document.

Yet another aspect of the invention includes a method of navigating between a first selected portion of a document and a second selected portion of a document, wherein the method includes searching a database that includes a plurality of referential links generated from the document, identifying at least one referential link that links the first selected portion and the second selected portion, extracting the link from the database, and forming a referential path between the first selected portion and the second selected portion based upon the identified link.

A further aspect of the invention includes a method of navigating between a selected portion of a first document and a selected portion of a second document, wherein the method includes searching a database that includes a plurality of referential links generated from the first document and the second document, identifying at least one referential link that links the selected portion of the first document and the selected portion of the second document, extracting the link from the database, and forming a referential path between the selected portion of the first document and the selected portion of the second document based upon the identified link.

### BRIEF DESCRIPTION OF THE DRAWINGS

The preferred and alternative embodiments of the present invention are described in detail below with reference to the following drawings.

FIG. 1 is a graphical view of a portion of an hierarchical document tree in accordance with the prior art;

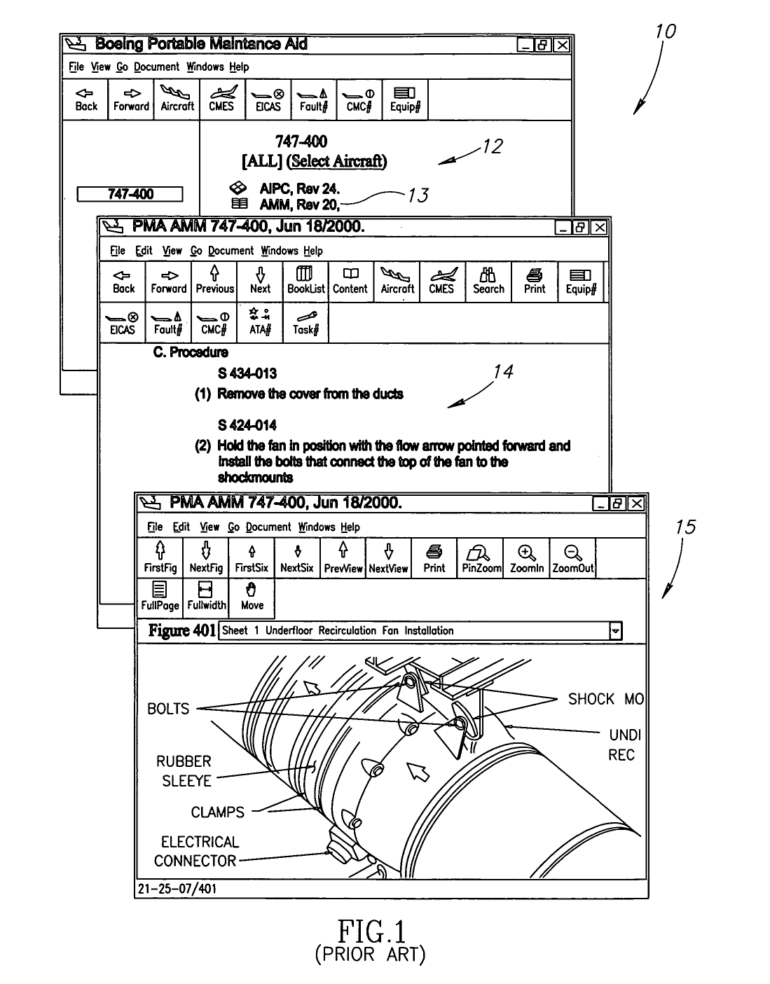

FIG. 2 is a block view of a system for acquiring a referential document link to form a referential path between selected document portions according to an embodiment of the invention;

FIG. 3 is a flowchart of a method for identifying one or more referential links according to still another embodiment of the invention;

FIG. 4 is a graphical representation of a plurality of hierarchical document trees used to describe a method for navigating within and/or between document trees according to yet another embodiment of the invention; and

FIG. 5 is a graphical representation of a hierarchical document tree that will be used to describe a method for generating a document tree according to another embodiment of the invention.

### DETAILED DESCRIPTION OF THE INVENTION

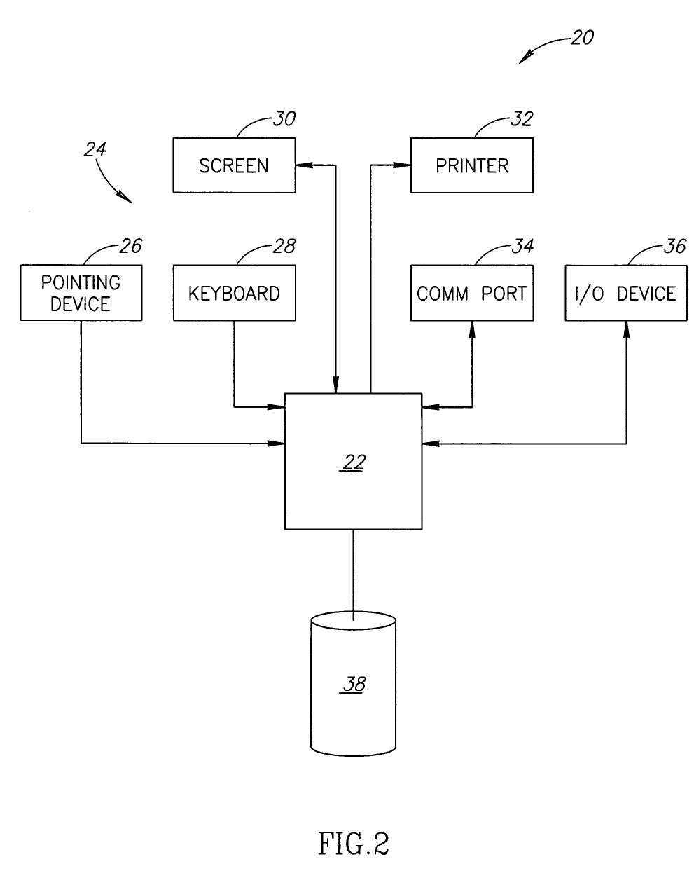

The present invention relates to systems and methods for accessing information from related document trees. Many specific details of certain embodiments of the invention are set forth in the following description and in FIGS. 2 through 5 to provide a thorough understanding of such embodiments. One skilled in the art, however, will understand that the present invention may have additional embodiments, or that the present invention may be practiced without several of the details described in the following description.

FIG. 2 is a block view of a system 20 for acquiring a referential document link to form a referential path between selected document portions according to an embodiment of the invention. The system 20 includes a processor 22, which generally includes any programmable electronic device configured to receive programming instructions and input data, and to process the data according to the programming instructions. The processor 22 is coupled to a plurality of external devices 24, including a pointing device 26 operable to provide input commands to the processor 22, a keyboard 28 for the entry of text information and commands to the processor 22, a viewing screen 30 for viewing information generated by the processor 22. Other external devices 24 include a printer 32 operable to generate a printed copy of information generated by the processor 22, and a communications port 34 that may be coupled to other processors and/or input and output devices through a communications network. A storage device 36 configured to receive a removable data storage medium, such as a magnetic disk, an optical disk, a tape device or other similar input/output devices is also coupled to the processor 22 so that information generated by the processor may be transferred to the removable storage medium.

The system 20 further includes a referential database 38 that includes a plurality of referential links, as disclosed in our co-pending U.S. patent application (Boeing Disc1. No. 03-1144) Ser. No. XX/XXX,XXX, entitled “SYSTEM AND METHOD FOR GENERATING AND STORING REFERENTIAL LINKS IN A DATABASE”, filed May XX, 2004 under attorney docket number BOEI-1-XXXX, which application is incorporated by reference herein. Briefly, and in general terms, the referential database 38 includes referential links extracted from data structures that are correlated according to selected association or “business rules” and stored in a database in discrete data fields. The data structure disclosed in the foregoing application may include, for example, an extended markup language (XML) document having semantic tags that describe particular data elements therein. The data structure is, in turn, generated from a written document. For example, the data structure may be generated from an electronic document formatted in the well-known portable document format (PDF), or it may include a paper document that is scanned into an electronic document using optical character recognition (OCR) methods, as disclosed in our co-pending U.S. Patent Application (Boeing Disc1. No. 03-1143) No. YY/YYY,YYY, entitled “DOCUMENT INFORMATION MINING TOOL,” filed Apr. 30, 2004 under attorney docket number BOEI-1-1257, which application is also incorporated by reference herein.

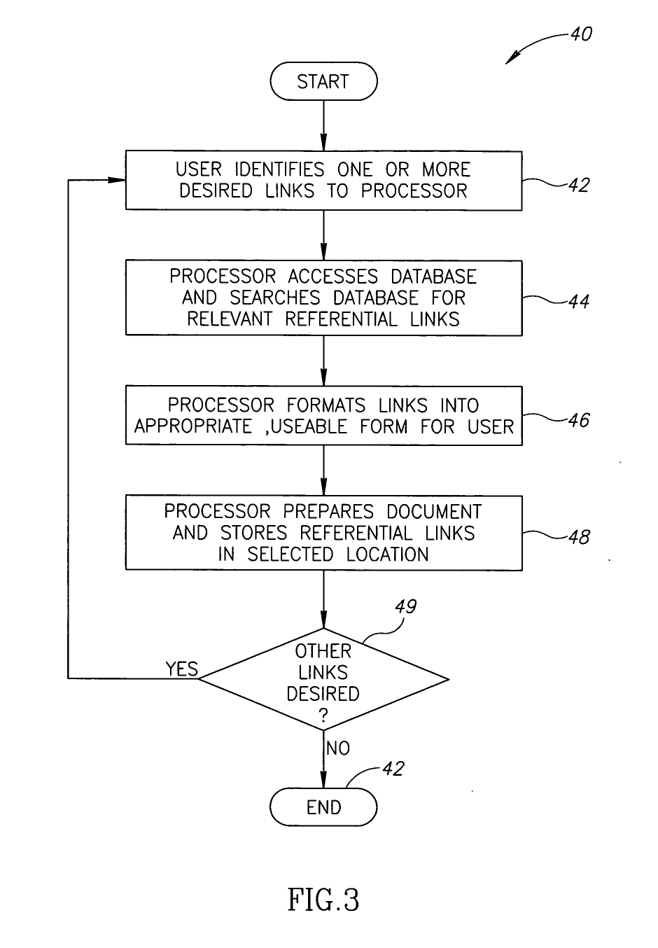

FIG. 3 is a flowchart of a method 40 for identifying one or more referential links according to still another embodiment of the invention. The method 40 commences at a block 42, where a user indicates that a referential link that forms a path between selected portions of one or more document trees is desired. In general, the user indicates that a link is sought between the selected portions by entering descriptive information from each of the selected portions. Accordingly, the block 42, the user provides the descriptive information for the first document portion, and also enters descriptive information for the one or more other document portions from either the same, or other document trees. The descriptive information may be provided, for example, by page numbers, document section numbers, file names, or even by pre-selected descriptors that are positioned on the respective document portions. Referring again to FIG. 2, the user may provide the descriptive information to the system 20 through the pointing device 26, the keyboard 28, or through the communications port 34. At a block 44, the processor 22 accesses the database 38 and extracts the relevant referential links based upon the descriptive information provided at step 42. The processor 22 then formats the extracted referential links so that the links are presented to the user in a useable form. For example, the links may be formatted and presented to the user as hyperlinks so that the referential path between the document trees may be readily invoked. At a block 48, the processor 22 prepares a document that includes the referential links identified at the block 44. The document thus generated may be presented to the user on the display screen 30, or a printed document may be generated on the printer 32. In either case, the document may also be stored on a removable memory medium within the storage device 36. Alternately, the document may be transferred to other processors and/or devices through the communication port 34.

Still referring to FIG. 3, the method 40 then requests if other referential links are required, as shown at a block 49. If no further link information is desired, the method 40 terminates. If further referential link information is desired, however, the method 40 returns to step 42 so that the user may enter additional descriptive information regarding the link sought.

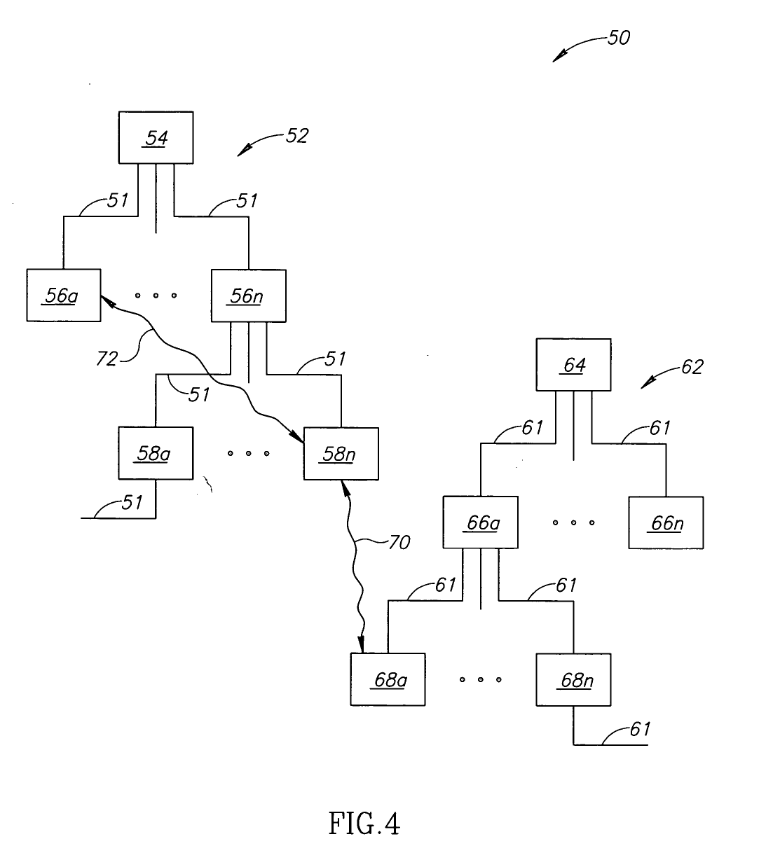

FIG. 4 is a graphical representation of a plurality of hierarchical document trees that will be used to describe a method 50 for navigating within and/or between document trees according to yet another embodiment of the invention. The method 50 includes a first document tree 52 having a root 54, branches 56a through 56n that depend from the root 54, and various sub-branches that depend from the branches 56a through 56n. For clarity of illustration, only sub-branches 58a through 58n, which depend from branch 56n, are shown. One skilled in the art will readily understand that other sub-branches may be present, which may have still other branches depending therefrom. The root 54, branches 56a through 56n and the sub-branches 58a through 58n are connected by pre-existing paths 51 that stem from the authorship of the document. For example, where the root 54 is a table of contents for the document, the branches 56a through 56n may represent chapters listed in the table of contents, so that the links 51 comprise paths between the table of contents and the subject matter comprising each chapter.

With continued reference to FIG. 4, a second document tree 72 similarly includes a root 64, branches 66a through 66n that depend from the root 64, and various sub-branches that depend from the branches 66a through 66n. Again, for clarity of illustration, only sub-branches 68a through 68n, which depend from branch 66n, are shown. The root 64, branches 66a through 66n and the various sub-branches are connected by pre-existing paths 61 that stem from the structure of a document. With reference again to FIG. 3, the links identified in the block 44 may be used to form referential paths between the first document tree 52 and the second document tree 62. For example, a referential path 70 is advantageously formed between the sub-branch 58n of the first tree 52 and the sub-branch 68a of the second tree 62, thus avoiding the need to navigate upwardly from the sub-branch 58n to the root 54, and then from the root 64 in the second tree 62 downwardly to the sub-branch 68a.

The method 50 may also permit navigation within a document tree. For example, a referential path 72 may be established between the branch 56a of the first tree 52 and the sub-branch 58n, also of the first tree 52. As a result, when navigation between the sub-branch 58n and the branch 56a is desired, the referential path 72 advantageously provides a direct path, thus avoiding the need to navigate upwardly from the sub-branch 58n to the branch 56n and upwardly further to the root 54, then downwardly from the root 54 to the branch 56a.

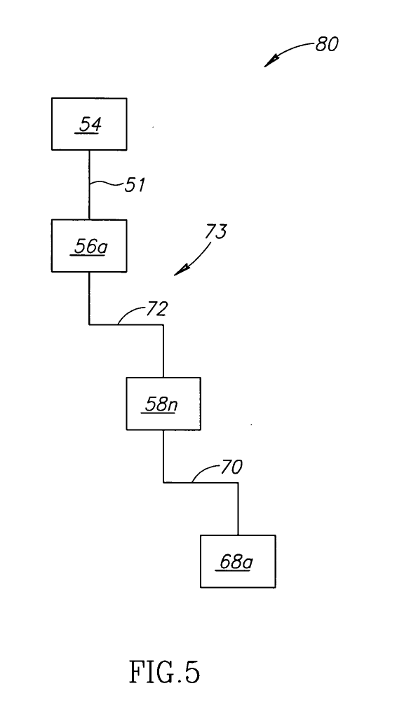

FIG. 5 is a graphical representation of a hierarchical document tree that will be used to describe a method 80 for generating a document tree according to another embodiment of the invention. The referential paths 70 and 72, as shown in FIG. 4 may be used to define a third document tree 73 that includes document portions from the first document tree 52 and the second document tree 62. Accordingly, the third document tree 73 includes the root 54, the branch 56a and the sub-branch 58n from the first tree 52, and the sub-branch 68a from the second document tree 62. In the exemplary third document tree 73, pre-existing links 51 and the referential paths 70 and 72 form a primary path between the root 54 and underlying portions of the document tree 73. The third document tree 73 may be combined with other document trees in order to form still more document trees having different root, branch and sub-branch portions and having different referential paths.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A system for acquiring a referential document link, comprising:
a database having a plurality of referential links obtained from at least a first source document and a second source document; and
a processor in communication with the database and operable to search the database for one or more referential links according to one or more predetermined criteria and to extract the one or more referential links from the database, the one or more extracted links defining one or more referential paths between the first source document and the second source document.

2. The system of claim 1, wherein the first source document and the second source document are respective portions of a common document tree.

3. The system of claim 1, wherein the first source document is selected from a first document tree and the second source document is selected from a second document tree.

4. The system of claim 1, wherein the processor is further operable to format the extracted link as a hyperlink.

5. The system of claim 1, wherein the referential links within the database are hyperlinks.

6. The system of claim 1, further comprising a plurality of external devices in communication with the processor.

7. The system of claim 6, wherein the plurality of external devices includes a keyboard and a pointing device operable to provide commands and data to the processor.

8. The system of claim 6, wherein the plurality of external devices includes a viewing screen operable to receive information generated by the processor and to display the information.

9. The system of claim 6, wherein the plurality of external devices includes a memory device operable to store information generated by the processor.

10. The system of claim 6, wherein the plurality of external devices includes a communications port operable to communicate information generated by the processor to a communications network.

11. A method of forming at least one referential link between a first selected portion of a document and a second selected portion of a document, comprising:
specifying a first descriptor associated with the first selected portion and a second descriptor associated with the second selected portion;
accessing a database that includes a plurality of referential links;
identifying the at least one referential link that defines a corresponding referential path between the first selected portion and the second selected portion;
extracting the at least one referential link from the database; and
using the referential path to provide a user-manipulable functional link to refer a user from the first selected portion to the second selected portion.

12. The method of claim 11, wherein accessing a database that includes a plurality of referential links comprises accessing a database including a plurality of hyperlinks.

13. The method of claim 11, wherein specifying a first descriptor associated with the first selected portion and a second descriptor associated with the second selected portion comprises providing the first and the second descriptor to a processor through a data input device coupled to the processor.

14. The method of claim 11, wherein specifying a first descriptor associated with the first selected portion and a second descriptor associated with the second selected portion comprises providing a first descriptor and a second descriptor that includes at least one of a page number, a document section number and a file name associated with the first and second selected portions.

15. The method of claim 11, wherein the first selected portion of a document comprises a selected portion of a document in a first document tree, and the second selected portion of a document comprises a selected portion of a document in a second document tree; further wherein specifying a descriptor associated with the first selected portion comprises selecting a descriptor from the selected portion in the first document tree and selecting a descriptor from the selected portion in the second document tree.

16. The method of claim 11, wherein using the referential path to provide a user-manipulable functional link comprises placing the link in a user-retrievable document.

17. The method of claim 11, wherein using the referential path to provide a user-manipulable functional link comprises communicating the link over a communications network.

18. A method of creating at least one referential link between a selected portion of a first document tree and a selected portion of a second document tree, comprising:
identifying a first descriptor associated with the selected portion of the first document tree and a second descriptor associated with the selected portion of the second document tree;
searching a database having a plurality of referential links obtained from the first document tree and the second document tree;
selecting at least one referential link from the database to form a corresponding referential path between the selected portion of the first document tree and the selected portion of the second document tree; and
navigating from the selected first portion of the first document tree to the selected portion of the second document tree along the referential path.

19. The method of claim 18, wherein searching a database having a plurality of referential links comprises searching a database having a plurality of hyperlinks.

20. The method of claim 18, wherein identifying a first descriptor associated with the selected portion of the first document tree and a second descriptor associated with the selected portion of the second document tree comprises providing the first and the second descriptors to a processor through a data input device coupled to the processor.

21. The method of claim 18, wherein identifying a first descriptor associated with a selected portion of a first document tree and a second descriptor associated with a selected portion of a second document tree comprises providing descriptors selected from the group including a page number, a document section number and a file name associated with respective selected portions of the first document tree and the second document tree.

22. The method of claim 18, further comprising placing at least one the referential link in a user-retrievable document.

23. The method of claim 18, further comprising communicating the at least one referential link over a communications network.

24. The method of claim 18, further comprising identifying a third descriptor associated with a selected first portion of the first document tree, and identifying a fourth descriptor associated with a selected second portion of the first document tree; and wherein selecting at least one referential link from the database comprises selecting a referential link to form a corresponding referential path between the selected first portion and the selected second portion of the first document tree.

25. A displayable document generated from a database comprised of a plurality of referential links obtained from a first source document and a second source document, comprising:
at least one referential link that forms a corresponding referential path from a selected portion of the first source document to a selected portion of the second source document.

26. The displayable document of claim 25, wherein the at least one referential link further comprises a hyperlink.

27. The displayable document of claim 25, wherein the first source document comprises a first document tree, and the second source document comprises a second document tree.

28. The displayable document of claim 25, wherein the document comprises one of a printed document, a hypertext document and a raster image on a viewing device.

29. A computer readable medium generated from a database comprised of a plurality of referential links obtained from a first source document and a second source document, comprising:
at least one referential link encoded thereon that forms a corresponding referential path from a selected portion of the first source document to a selected portion of the second source document.

30. The computer readable medium of claim 29, wherein the at least one referential link further comprises a hyperlink.

31. The computer readable medium of claim 29, wherein the first source document comprises a first document tree, and the second source document comprises a second document tree.

32. The computer readable medium of claim 29, wherein the medium comprises one of a magnetic disk device, an optical disk device, a tape device and a computer network.

33. A method of navigating between a first selected portion of a document and a second selected portion of a document, comprising:
searching a database that includes a plurality of referential links generated from the document;
identifying at least one referential link that links the first selected portion and the second selected portion;
extracting the link from the database;
forming a referential path between the first selected portion and the second selected portion based upon the identified link; and
moving from the first selected portion of the document and the second selected portion of the document.

34. The method of claim 33, wherein forming a referential path comprises forming a user-navigable link between the first selected portion and the second selected portion.

35. The method of claim 34, wherein forming a user-navigable link comprises forming a hyperlink.

36. The method of claim 33, wherein searching a database further comprises:
associating a first identifier with the first selected portion;
associating a second identifier with the second selected portion; and
locating the at least one referential link in the database based upon the first and second identifiers.

37. A method of navigating between a selected portion of a first document and a selected portion of a second document, comprising:
searching a database that includes a plurality of referential links generated from the first document and the second document;
identifying at least one referential link that links the selected portion of the first document and the selected portion of the second document;
extracting the link from the database;
forming a referential path between the selected portion of the first document and the selected portion of the second document based upon the identified link; and
moving from the selected portion of the first document to the selected portion of the second document.

38. The method of claim 37, wherein forming a referential path comprises forming a user-navigable link between the first selected portion and the second selected portion.

39. The method of claim 37, wherein forming a user-navigable link comprises forming a hyperlink.

40. The method of claim 37, wherein searching a database further comprises:
associating a first identifier with the selected portion of the first document;
associating a second identifier with the selected portion of the second document; and
locating the at least one referential link in the database based upon the first and second identifiers.

41. A method of generating a new document tree from a pre-existing document tree, comprising:
identifying at least one referential link defining at least one referential path between a first selected portion of a document tree and a second selected portion of the document tree, the referential links being derived from the document tree and stored in a database;
extracting the at least one referential link from the database; and
interposing the at least one referential path between the first selected portion and the second selected portion to define a document tree distinct from the pre-existing document tree.

42. The method of claim 41, wherein interposing the at least one referential path comprises forming a user-navigable link between the first selected portion and the second selected portion.

43. The method of claim 42, wherein forming a user-navigable link comprises forming a hyperlink.

44. The method of claim 41, wherein identifying at least one referential link further comprises:
associating a first identifier with the first selected portion;
associating a second identifier with the second selected portion; and
locating the at least one referential link in the database based upon the first and second identifiers.

45. A method of generating a new document tree from a pre-existing first document tree and a pre-existing second document tree, comprising:
identifying at least one referential link defining at least one referential path between a selected portion of the first document tree and a selected portion of the second document tree, the referential links being derived from the first document tree and the second document tree and stored in a database;
extracting the at least one referential link from the database; and
interposing the at least one referential path between the selected portion of the first document tree and the selected portion of the second document tree to define a document tree distinct from the pre-existing first document tree and second document trees.

46. The method of claim 45, wherein interposing the at least one referential path comprises forming a user-navigable link between the selected portion of the first document tree and the selected portion of the second document tree.

47. The method of claim 46, wherein forming a user-navigable link comprises forming a hyperlink.

48. The method of claim 45, wherein identifying at least one referential link further comprises:
associating a first identifier with the selected portion of the first document tree;
associating a second identifier with the selected portion of the second document tree; and
locating the at least one referential link in the database based upon the first and second identifiers.
